(19) United States
(12) Patent Application Publication
(10) Pub. No.: US 2023/0368776 A1
(43) Pub. Date: Nov. 16, 2023

(54) CONTEXTUAL NOTIFICATION BASED ON VOICE COMMANDS

(71) Applicant: Statum Systems Inc., Wellesley, MA (US)

(72) Inventors: Stephen Michael Okajima, Boston, MA (US); Arman Serebrakian, Boston, MA (US); Ara Nazarian, Wellesley, MA (US); Frederick Lizza, Wellesley, MA (US); Per Suneby, Wellesley, MA (US)

(21) Appl. No.: 17/742,255

(22) Filed: May 11, 2022

(51) Int. Cl. G10L 15/02; G10L 15/18; G10L 15/22; G06F 3/16

(52) U.S. Cl. CPC G10L 15/02; G10L 15/18; G10L 15/22; G06F 3/16

(57) ABSTRACT

A contextual notification system to perform operations that include: receiving a speech signal that comprises speech data via an input component; accessing a message repository associated with a user profile, the message repository comprising one or more messaging sessions, each messaging session among the one or more messaging sessions comprising a set of terms and corresponding with a set of user identifiers associated with one or more users engaged in each messaging session; performing natural language processing upon the speech data; detecting, based on the natural language processing performed upon the speech data, a term from among a set of terms associated with a messaging session from among the one or more messaging sessions associated with the user profile, the messaging session corresponding with at least a user identifier; and causing display of a notification at a client device associated with the user identifier based on the term.

### TECHNICAL FIELD

The present invention relates to graphical user interfaces, and more specifically, relates to systems and methods to facilitate notification management within graphical user interfaces.

### BACKGROUND

Graphical user interfaces for electronic and other devices often allow speech-based inputs. For example, a user may provide a voice command to control various features or operations of a device. Natural language processing is a type of machine learning applied to the interpretation of speech inputs. Speech recognition may convert the input to text. The text may thereby be analyzed using various Natural Language Processing (NLP) techniques to determine a command to be performed.

### BRIEF DESCRIPTION OF THE DRAWINGS

Some embodiments are illustrated by way of example and not limitation in the figures of the accompanying drawings in which:

FIG. 1 is a network diagram depicting a client-server system, within which one example embodiment may be deployed.

FIG. 2 is a block diagram illustrating components of a contextual notification system, according to some example embodiments.

FIG. 3 is a flowchart illustrating operations of the contextual notification system in performing a method presenting a notification based on a voice command, according to some example embodiments.

FIG. 4 is a flowchart illustrating operations of the contextual notification system in performing a method presenting a notification based on a voice command, according to some example embodiments.

FIG. 5 is an interface diagram depicting a notification presented by a contextual notification system, according to some example embodiments.

FIG. 6 is a diagrammatic representation of a machine in the example form of a computer system within which a set of instructions may be executed for causing the machine to perform any one or more of the methodologies discussed herein.

### DETAILED DESCRIPTION

Reference will now be made in detail to specific example embodiments for carrying out the inventive subject matter. Embodiments may be practiced without some or all of these details. It will be understood that the forgoing disclosure is not intended to limit the scope of the claims to the described embodiments. On the contrary, it is intended to cover alternatives, modifications, and equivalents as may be included within the scope of the disclosure as defined by the appended claims. In addition, well known features may not have been described in detail to avoid unnecessarily obscuring the subject matter.

As discussed above, various systems exist to enable users to perform various operations or commands at a user device using voice commands provided to the user device. Typically, these systems may employ various NLP techniques to identify relevant terms provided within a natural language voice-command, in order to determine a relevant command to be executed at a client device. While these systems are effective in their ability to discern specific commands, they lack the intelligence to execute complex workflows without explicit user instruction. Therefore, described herein is a system to enable contextual distribution of notifications based on voice commands received at a client device.

According to certain example embodiments, a contextual notification system is configured to perform operations that include: receiving a speech signal that comprises speech data via an input component; accessing a message repository associated with a user profile, the message repository comprising one or more messaging sessions, each messaging session among the one or more messaging sessions comprising a set of terms and corresponding with a set of user identifiers associated with one or more users engaged in each messaging session; performing natural language processing upon the speech data of the speech signal; detecting, based on the natural language processing performed upon the speech data, a term from among a set of terms associated with a messaging session from among the one or more messaging sessions associated with the user profile, the messaging session corresponding with at least a user identifier; and causing display of a notification at a client device associated with the user identifier based on the term.

According to certain example embodiments, each messaging session among the one or more messaging sessions may include a session identifier, wherein the session identifier indicates a subject matter associated with the messaging session. For example, in the context of an embodiment directed to medical communication, the session identifier may include a name, such as a patient name. Accordingly, the messaging session may further comprise one or more user identifiers associated with medical professionals attending to the patient, such as nurses, as well as on-call doctor and staff.

Similarly, in some embodiments, the set of terms associated with the messaging session may comprise one or more terms extracted from an Electronic Health Record (EHR) associated with a patient referenced within the messaging session. Accordingly, the system may build a library of trigger terms associated with each messaging session based on messages received within the messaging session, as well as the EHR that corresponds with the patient. For example, to initiate a messaging session for a patient, a user (such as a nurse or doctor) may provide inputs to name the messaging session, and to associate one or more user identifiers with the messaging session, wherein the one or more user identifiers correspond with medical professionals attending to the patient. The user may further associate an EHR record associated with the patient to the messaging session.

In some embodiments, responsive to initiating the messaging session for the patient, the contextual notification system may generate a library of trigger words based on contents of the messaging session (i.e., messages sent and received within the messaging session), as well as contents of the EHR record associated with the patient. For example, the contextual notification system may access the messaging session, and the EHR record to extract terms to be added to the library of trigger words associated with the patient. Accordingly, responsive to receiving a speech signal that contains a trigger word found in the library of trigger words associated with the patient, the contextual notification may generate and present a notification to at least a portion of users associated with the one or more user identifiers, wherein the notification includes an identifier associated with the patient (i.e., a name), and the detected trigger word.

In some embodiments, certain trigger words may be associated with specific patient care scenarios, wherein the patient care scenarios correspond with a workflow which may be defined by an administrator associated with the system. A workflow may indicate specific actions to be taken by relevant personnel associated with an organization. For example, the specific actions may include but is not limited to: requesting authorization or signatures from relevant individuals; retrieval of specific files; performance of tests upon a patient; initiation of discharge processes; as well as transmission of documents or other data to relevant personnel.

In some embodiments, the system may be configured to perform NLP upon the speech data responsive to a request to activate an input component associated with the client device. For example, a user of a client device may provide an input to activate the input component, wherein the input may include a selection of a graphical icon presented at the client device, pressing of a physical button associated with the client device, or in some embodiments, a trigger command provided as a voice command at the client device.

In some embodiments, terms may be associated with workflows that define who is to be notified of a given situation, and attributes of the notification to be presented. For example, a term from among the set of trigger terms may be marked as high priority, such that detection of a high priority trigger term may cause the contextual notification system to present a high priority alert, or otherwise prioritize a notification to be presented to all users associated with the corresponding messaging session. For example, terms like: emergency; cardiac arrest; non-responsive; critical; and the like, may be marked as high priority such that upon receiving a voice command that includes the term may cause the contextual notification system to present a high priority alert.

Similarly, the phrase “ready for discharge” may cause the contextual notification system to notify a subset of the users associated with the messaging session based on roles of the subset of users. Accordingly, upon receiving a voice command that includes the term “ready for discharge,” the contextual notification system may present the generated notification to a team of individuals responsible for patient discharge, such as a nurse. Similarly, if the voice command includes the term “cardiac arrest,” the contextual notification system may be configured to identify a user associated with a role of “cardiologist on call” in order to present a notification to the user at a corresponding client device.

Notification criteria and attributes may be associated with each role among a plurality of possible roles within a database associated with a server of the system, as well as at a client device associated with a user. In doing so, filtering and configuration of notifications may occur at the client device itself, based on notification data received from server side. In further embodiments, the server may itself configure notifications based on the set of notification criteria associated with the recipients of the notifications.

Notification attributes of a notification may include: graphical properties of the notifications; alert properties of an alert associated with the notification, including whether or not an alert is presented or not; message and media content associated with the notification; and a distribution list associated with the notification. Notifications may be presented at a client device based on the corresponding notification attributes, wherein the notification attributes may be defined based on explicit user input or based on properties of message and media content associated with the notification. For example, a notification may include “high priority” content, which may correspond with a predefined set of notification attributes.

In some embodiments, the system may dynamically update a repository (i.e., database) that maintains and updates records of patients and doctors based on contents of the messaging sessions. The system may therefore maintain records comprising patient identifiers, wherein the patient identifiers may be associated with a set of patient attributes that include: demographics information, such as age, sex, gender, height, and weight; a listing of medical records associated with the patient (i.e., EHR data); temporal data indicating a time and date of admittance to a hospital or clinical environment; location data; and an identification of attending doctors, physicians, and staff that have worked with the patient (i.e., based on doctor/user identifier). Similarly, the system may also maintain records comprising doctor identifiers (i.e., user identifiers), wherein the doctor identifiers may be associated with a set of doctor/user attributes that include: area of specialty; work schedule; a listing of patient identifiers which the doctor/user is working with; as well as location data indicating hospitals and clinics in which the doctor has scheduled hours.

In some embodiments, the contextual notification system may distribute the notification to the one or more recipients by distributing the notification to an auxiliary device associated with the one or more recipients which is communicatively coupled to a client device associated with the one or more recipients, wherein the notification may then be presented at one or more client devices associated with the one or more recipients based on notification criteria which are associated with each of the one or more recipients.

As an illustrative example from a user perspective in the context of medical communication, a user of the contextual notification system may be a medical professional working within a hospital or clinic environment, and wherein the user is engaged in one or more messaging sessions within a messaging platform, and wherein each messaging session corresponds with a patient in which the user is attending to. Accordingly, the messaging session may include user identifiers associated with all medical professionals on-call or otherwise attending to the patient, such that all communications associated with the patient may be shared through the messaging session.

After attending to the patient in person, the user may determine that the patient (“John Doe”) is ready to be discharged from the hospital. The user may provide a natural language voice command at their client device, wherein the voice command includes an identification of the patient, as well as one or more terms. For example, the user may provide a natural language voice command such as: “John Doe is ready for discharge.”

Upon receiving the voice command, the system may perform NLP upon the speech data of the voice command to identify one or more relevant terms. Determination of relevant terms may be contextual, based on the messaging sessions in which the user is engaged. Accordingly, the system may access a message repository associated with the user to identify one or more messaging sessions, wherein each messaging session comprises a patient name, a list of user identifiers, and one or more terms. The system may thereby access a trigger word library associated with a patient identified by the voice command, wherein the trigger word library includes one or more of the terms provided to the system within the voice command.

Upon identifying a trigger word from among the corresponding set of trigger words, the contextual notification system may determine a relevant workflow to be performed based on the voice command. For example, the workflow may include a discharge process in which specific personnel are notified in order to initiate the patient discharge process, authorization is requested from a relevant doctor, and a shuttle is requested to drive the patient home.

The contextual notification system may then generate a notification to be presented to the relevant personnel, wherein the notification may present information relevant to the individual users based on their corresponding roles. For example: a doctor attending to the patient may be presented with a notification indicating that authorization is requested to discharge the patient; a nurse may be presented with a notification indicated that they are to initiate their discharge procedures; and a shuttle service driver may be presented with a notification indicating that they are to pick up a patient at a specific location within 30 minutes.

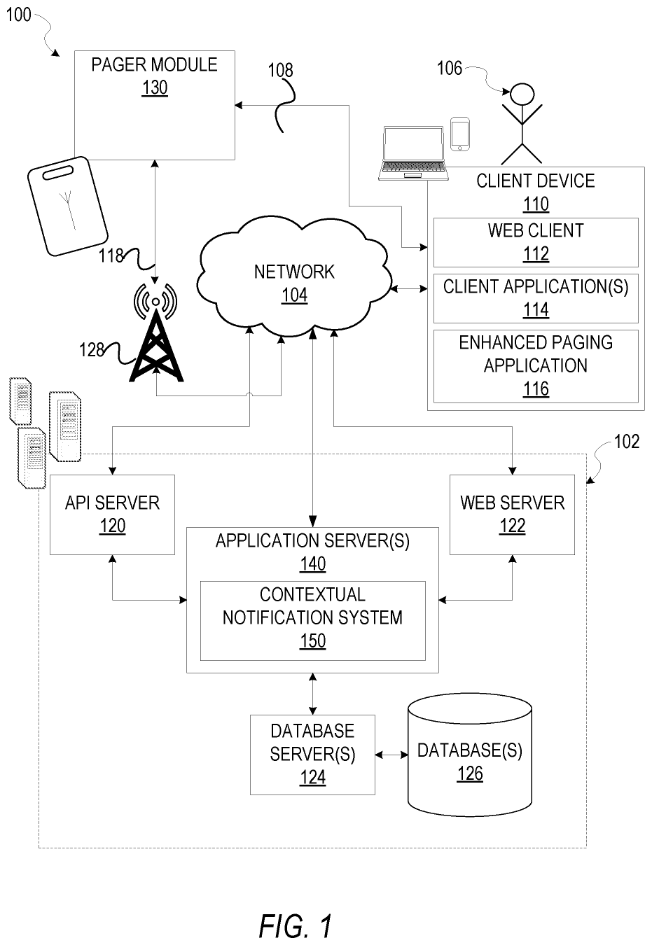

FIG. 1 is an example embodiment of a high-level client-server-based network architecture 100. A networked system 102, in the example form of a pager network, provides server-side functionality via a network 104 (e.g., the Internet or wide area network (WAN), Bluetooth) to one or more client devices 110. FIG. 1 illustrates, for example, a web client 112 (e.g., a browser, such as the Internet Explorer® browser developed by Microsoft® Corporation of Redmond, Washington State), client application(s) 114, and an enhanced paging application 116 executing on the client device 110.

The client device 110 may comprise, but is not limited to, a wearable device, mobile phone, desktop computer, laptop, portable digital assistant (PDA), smart phone, tablet, ultra-book, netbook, laptop, multi-processor system, microprocessor-based or programmable consumer electronics, game console, set-top box, or any other communication device that a user may utilize to access the networked system 102. In some embodiments, the client device 110 comprises a display module (not shown) to display information (e.g., in the form of user interfaces). In further embodiments, the client device 110 comprises one or more of touch screens, accelerometers, gyroscopes, cameras, microphones, global positioning system (GPS) devices, and so forth. The client device 110 may be a device of a user configured to facilitate communication within the networked system 102. One or more portions of the network 104 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the public switched telephone network (PSTN), a cellular telephone network, a wireless network, a WiFi network, a WiMax network, a Wireless Mesh Network (WMN), or a combination of two or more such networks.

The client device 110 may include one or more client applications 114 (also referred to as “apps”) such as, but not limited to, a web browser, messaging application, electronic mail (email) application, a navigation application, and the like. In some embodiments, the client application(s) 114 is configured to locally provide the user interface and at least some of the functionalities with the client application(s) 114 configured to communicate with the networked system 102, on an as needed basis, for data or processing capabilities not locally available (e.g., access to a database of items available for sale, to authenticate a user, to verify a method of payment). Conversely, the client device 110 may use its web browser to access data hosted on the networked system 102 to generate and provide various user interfaces.

A pager module 130 may be communicatively coupled to the client device 110 via one or more communication pathways 108. For example, the communication pathways 108 may be an indirect communicative connection or direct communicative connection (e.g., without intervening components), whether wired or wireless, including but not limited to connections such as electrical, optical, magnetic, and near-field communication (NFC). For example, in some embodiments, the pager module 130 may be communicatively coupled to the client device via Bluetooth or Bluetooth Low Energy (BLE). In some embodiments, the pager module 130 may include one or more antenna, wherein the antenna are tuned to receive data via one or more specified communication bands, including but not limited to Very High Frequency (VHF), and in some instances Ultra High Frequency (UHF) bands. VHF, and in some instances, UHF, bands of the radio spectrum offer higher signal penetration and range than higher frequency bands typically used in Wi-Fi and cellular networks. Accordingly, the pager module 130 may be configured to receive data via a 4-bit Binary-coded decimal (BCD) values, as well as 7-bit American Standard Code for Information Interchange (ASCII). According to such embodiments, the network 104 may additionally include a pager network, wherein the pager network comprises a plurality of transmitter antennas configured to distribute data to the pager module 130 (i.e., an auxiliary device 130) via a communication pathway 118 that comprises a predefined set of frequencies, including but not limited to VHF and UHF.

One or more users 106 may be a person, a machine, or other means of interacting with the client device 110. In example embodiments, the user 106 is not part of the network architecture 100, but may interact with the network architecture 100 via the client device 110 or other means. For instance, the user 106 provides input (e.g., touch screen input, alphanumeric input, text-to-speech, or speech-to-text) to the client device 110 and the input is communicated to the networked system 102 via the network 104. In this instance, the networked system 102, in response to receiving the input from the user 106, communicates information to the client device 110 via the network 104 to be presented to the user 106. In this way, the user 106 can interact with the networked system 102 using the client device 110.

An application program interface (API) server 120 and a web server 122 are coupled to, and provide programmatic and web interfaces respectively to, one or more application servers 140. The application server(s) 140 may host an contextual notification system 150, for providing a means of voice-command based notification. For example, the contextual notification system 150 may generate and present notifications in response to requests from the client device 110, wherein the requests may include voice commands received at an input component of the client device 110.

While the client-server-based network architecture 100 shown in FIG. 1 employs a client-server architecture, the present inventive subject matter is of course not limited to such an architecture, and could equally well find application in a distributed, or peer-to-peer, architecture system, for example. The contextual notification system 150 could also be implemented as standalone software programs, which do not necessarily have networking capabilities.

The web client 112 may access the various publication and payment systems 142 and 144 via the web interface supported by the web server 122. Similarly, the enhanced paging application 116 accesses the various services and functions provided by the contextual notification system 150 via the programmatic interface provided by the API server 120. The enhanced paging application 116 may, for example, generate and cause display of notifications in response to receiving message data from an associated pager module 130.

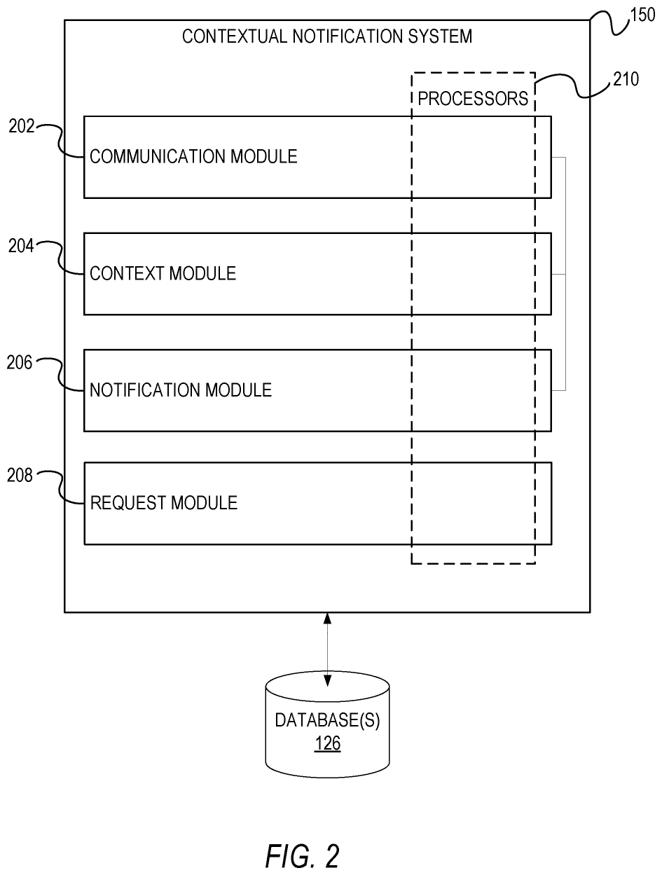

FIG. 2 is a block diagram illustrating components of the contextual notification system 150 that configure the contextual notification system 150 to perform operations that include: receiving a speech signal that comprises speech data via an input component; accessing a message repository associated with a user profile, the message repository comprising one or more messaging sessions, each messaging session among the one or more messaging sessions comprising a set of terms and corresponding with a set of user identifiers associated with one or more users engaged in each messaging session; performing natural language processing upon the speech data of the speech signal; detecting, based on the natural language processing performed upon the speech data, a term from among a set of terms associated with a messaging session from among the one or more messaging sessions associated with the user profile, the messaging session corresponding with at least a user identifier; and causing display of a notification at a client device 110 associated with the user identifier based on the term.

The contextual notification system 150 is shown as including a communication module 202, a context module 204, a notification module 206, and a request module 208, all configured to communicate with each other (e.g., via a bus, shared memory, or a switch). Any one or more of these modules may be implemented using one or more processors 210 (e.g., by configuring such one or more processors 210 to perform functions described for that module) and hence may include one or more of the processors 210. In some embodiments, the modules of the contextual notification system 150 may be in coupled with the databases 126.

Any one or more of the modules described may be implemented using hardware alone (e.g., one or more of the processors 210 of a machine) or a combination of hardware and software. For example, any module described of the contextual notification system 150 may physically include an arrangement of one or more of the processors 210 (e.g., a subset of or among the one or more processors of the machine) configured to perform the operations described herein for that module. As another example, any module of the contextual notification system 150 may include software, hardware, or both, that configure an arrangement of one or more processors 210 (e.g., among the one or more processors of the machine) to perform the operations described herein for that module. Accordingly, different modules of the contextual notification system 150 may include and configure different arrangements of such processors 210 or a single arrangement of such processors 210 at different points in time. Moreover, any two or more modules of the contextual notification system 150 may be combined into a single module, and the functions described herein for a single module may be subdivided among multiple modules. Furthermore, according to various example embodiments, modules described herein as being implemented within a single machine, database, or device may be distributed across multiple machines, databases, or devices.

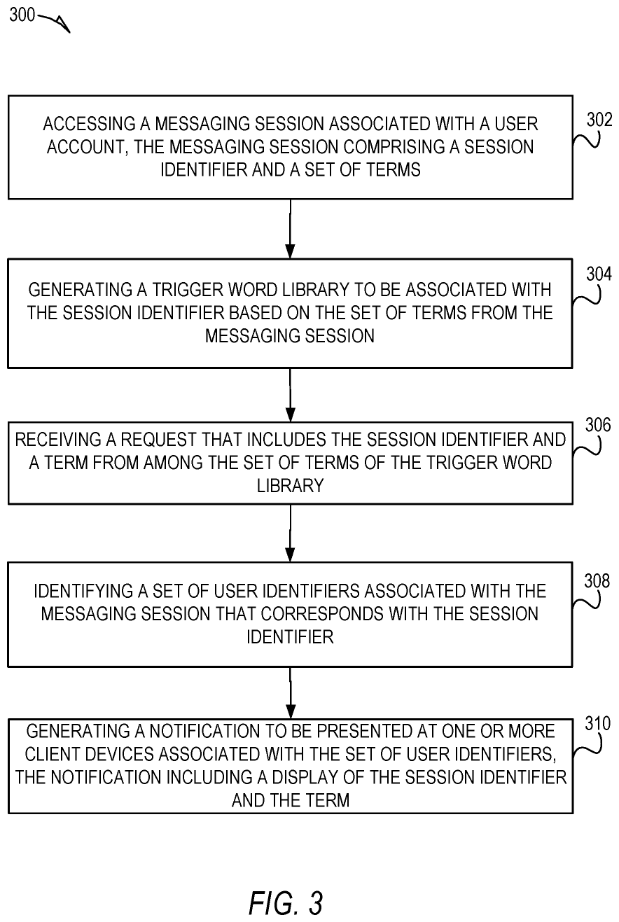

FIG. 3 is a flowchart illustrating a method 300 for presenting a notification based on a voice command, according to certain example embodiments. Operations of the method 300 may be performed by the modules described above with respect to FIG. 2. As shown in FIG. 3, the method 300 includes one or more operations 302, 304, 306, 308, and 310.

At operation 302, the communication module 202 accesses a plurality of messaging sessions associated with a user account, wherein each messaging session among the plurality of messaging sessions comprise session identifiers, and a set of terms. For example, the session identifiers may include a name, such as a patient name, and the set of terms may comprise messages sent within the messaging session, and EHR data. For example, the EHR data may correspond with an individual in which the messaging session relates to, such as a patient.

At operation 304, the context module 204 generates a trigger word library based on the set of terms from the messaging session, wherein the trigger word library is to be associated with the session identifier of the messaging session. Accordingly, by referencing the session identifier, the context module 204 may access the corresponding trigger word library.

At operation 306, the request module 208 receives a request that includes the session identifier and a term from among the set of terms of the trigger word library. For example, the request may include a voice command received at an input component of a client device 110, wherein the voice command comprises speech data.

At operation 308, responsive to the request module 208 receiving the request, the context module 204 identifies the session identifier indicated by the voice command, and accesses a messaging session identified by the session identifier, wherein the messaging session comprises one or more user identifiers associated with users engaged in the messaging session.

At operation 310, the notification module 206 generates a notification to be presented at one or more client devices 110, wherein the one or more client devices 110 are associated with the one or more user identifiers, and wherein the notification includes a display of the session identifier and the term from the request.

In some embodiments, the notification generated by the notification module 206 may be generated based on attributes associated with each user identified by the one or more user identifiers. Accordingly, the notification presented to a user may be tailored or customized based on the corresponding user attributes. For example, each user may correspond with a role, wherein the role defines various permissions and responsibilities associated with the user. Accordingly, attributes of the notification may be generated based on the user attributes of the recipient.

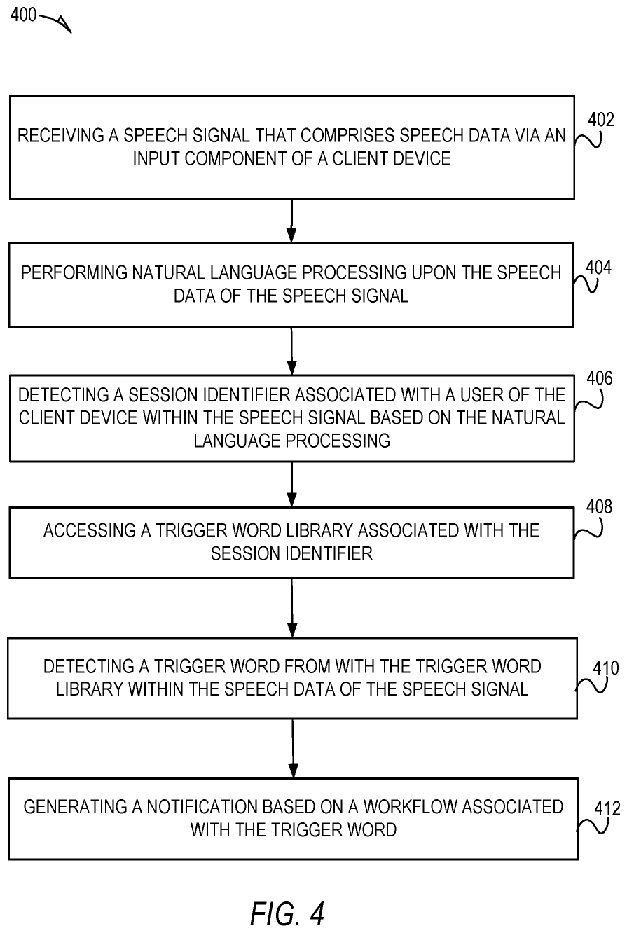

FIG. 4 is a flowchart illustrating a method 400 for presenting a notification based on a voice command, according to certain example embodiments. Operations of the method 400 may be performed by the modules described above with respect to FIG. 2. As shown in FIG. 4, the method 400 includes one or more operations 402, 404, 406, 408, 410, and 412.

At operation 402, the request module 208 receives a request that comprises a speech signal via an input component of a client device 110. For example, a user of the client device 110 may provide an input to activate the input component, and in response, the request module 208 may activate the input component to receive the speech signal.

At operation 404, the context module 204 performs one or more NLP techniques upon speech data of the speech signal. Accordingly, at operation 406, the context module 204 detects a session identifier associated with a user of the client device 110 (i.e., a session identifier associated with a messaging session in which the user of the client device 110 is engaged in), based on the NLP.

At operation 408, responsive to identifying the session identifier associated with the user of the client device 110, the context module 204 accesses a trigger word library associated with the session identifier, wherein the trigger word library comprises a set of terms associated with the messaging session.

At operation 410, the context module 204 detects a trigger word from the trigger word library within the speech data of the speech signal. Responsive to the context module 204 detecting the trigger word from the trigger word library within the speech data of the speech signal, the notification module 206 generates a notification based on a workflow associated with the trigger word.

For example, each trigger word among the trigger word library may correspond with a workflow that indicates who is to be notified based on the request. As an illustrative example, a user of the client device 110 may include a nurse on call. The nurse may provide a voice command indicating, “Jane Doe is 10 cm dilated!”

Responsive to receiving the voice command that comprises natural language speech data, the contextual notification system 150 may perform NLP upon the natural language speech data of the voice command in order to identifier a session identifier associated with a messaging session (i.e., “Jane Doe”), and a trigger word (i.e., “10 cm dilated”). The contextual notification system 150 may access the trigger word library associated with the session identifier to identify a workflow that corresponds with the trigger word. For example, the workflow may indicate that for patient Jane Doe, upon detecting a trigger word indicating “10 cm dilated,” corresponds with a patient care scenario in which an anesthesiologist on-call is to be notified with high priority.

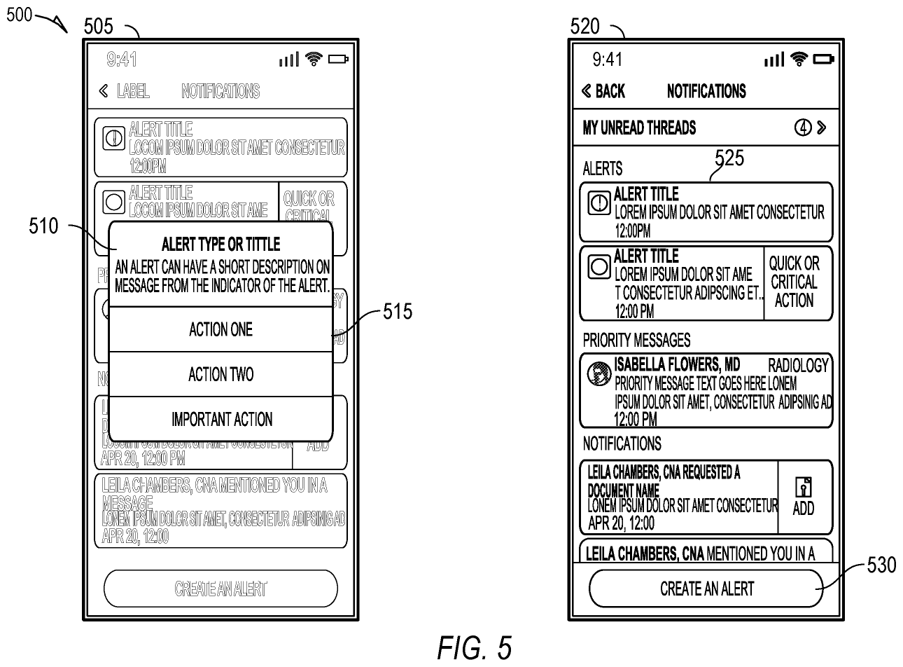

FIG. 5 is an interface diagram 500 depicting notifications presented by a contextual notification system 150, according to some example embodiments. The interface diagram 500 includes a depiction of a GUI 505, and a GUI 520, wherein the GUI 505 and GUI 520 may correspond with different users at distinct client device 110. Accordingly, as discussed above with relation to the method 400 of FIG. 4, attributes of a notification presented to the users may vary based on the user's corresponding user attributes.

For example, as seen in the GUI 505, a notification 510 may include a display of a request 515, wherein the request 515 requires response from a user. On the other hand, as seen in the GUI 520, the notification 525 may simply be presented as an element within a notification menu.

The GUI 520 also includes a display of a voice command activation icon 530, wherein a user of a client device 110 may provide an input to select the voice command activation icon 530 in order to activate an input component associated with the client device 110.

### Modules, Components and Logic

Certain embodiments are described herein as including logic or a number of components, modules, or mechanisms. Modules may constitute either software modules (e.g., code embodied on a machine-readable medium or in a transmission signal) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation, and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).)

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., a field programmable gate array (FPGA) or an application-specific integrated circuit (ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-Readable Medium

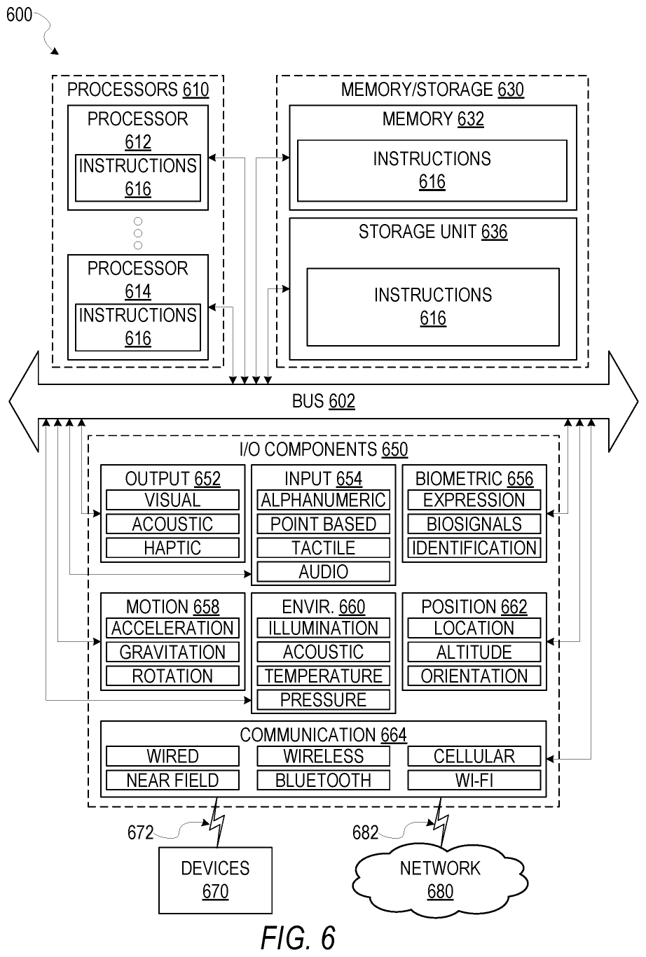

FIG. 6 is a block diagram illustrating components of a machine 600, according to some example embodiments, able to read instructions from a machine-readable medium (e.g., a machine-readable storage medium) and perform any one or more of the methodologies discussed herein. Specifically, FIG. 6 shows a diagrammatic representation of the machine 600 in the example form of a computer system, within which instructions 616 (e.g., software, a program, an application, an applet, an app, or other executable code) for causing the machine 600 to perform any one or more of the methodologies discussed herein may be executed. Additionally, or alternatively, the instructions may implement the modules of FIG. 2. The instructions transform the general, non-programmed machine into a specially configured machine programmed to carry out the described and illustrated functions in the manner described. In alternative embodiments, the machine 600 operates as a standalone device or may be coupled (e.g., networked) to other machines. In a networked deployment, the machine 600 may operate in the capacity of a server machine or a client machine in a server-client network environment, or as a peer machine in a peer-to-peer (or distributed) network environment.

The machine 600 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 616, sequentially or otherwise, that specify actions to be taken by machine 600. Further, while only a single machine 600 is illustrated, the term “machine” shall also be taken to include a collection of machines 600 that individually or jointly execute the instructions 616 to perform any one or more of the methodologies discussed herein.

The machine 600 includes processors 610, memory 630, and I/O components 650, which may be configured to communicate with each other such as via a bus 602. In an example embodiment, the processors 610 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) may include, for example, processor 612 and processor 614 that may execute instructions 616. The term “processor” is intended to include multi-core processor that may comprise two or more independent processors (sometimes referred to as “cores”) that may execute instructions contemporaneously. Although FIG. 6 shows multiple processors, the machine 600 may include a single processor with a single core, a single processor with multiple cores (e.g., a multi-core process), multiple processors with a single core, multiple processors with multiples cores, or any combination thereof.

The memory/storage 630 may include a memory 632, such as a main memory, or other memory storage, and a storage unit 636, both accessible to the processors 610 such as via the bus 602. The storage unit 636 and memory 632 store the instructions 616 embodying any one or more of the methodologies or functions described herein. The instructions 616 may also reside, completely or partially, within the memory 632, within the storage unit 636, within at least one of the processors 610 (e.g., within the processor's cache memory), or any suitable combination thereof, during execution thereof by the machine 600. Accordingly, the memory 632, the storage unit 636, and the memory of processors 610 are examples of machine-readable media.

As used herein, “machine-readable medium” means a device able to store instructions and data temporarily or permanently and may include, but is not be limited to, random-access memory (RAM), read-only memory (ROM), buffer memory, flash memory, optical media, magnetic media, cache memory, other types of storage (e.g., Erasable Programmable Read-Only Memory (EEPROM)) and/or any suitable combination thereof. The term “machine-readable medium” should be taken to include a single medium or multiple media (e.g., a centralized or distributed database, or associated caches and servers) able to store instructions 616. The term “machine-readable medium” shall also be taken to include any medium, or combination of multiple media, that is capable of storing instructions (e.g., instructions 616) for execution by a machine (e.g., machine 600), such that the instructions, when executed by one or more processors of the machine 600 (e.g., processors 610), cause the machine 600 to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes transitory signals per se.

The I/O components 650 may include a wide variety of components to receive input, provide output, produce output, transmit information, exchange information, capture measurements, and so on. The specific I/O components 650 that are included in a particular machine will depend on the type of machine. For example, portable machines such as mobile phones will likely include a touch input device or other such input mechanisms, while a headless server machine will likely not include such a touch input device. It will be appreciated that the I/O components 650 may include many other components that are not shown in FIG. 6. The I/O components 650 are grouped according to functionality merely for simplifying the following discussion and the grouping is in no way limiting. In various example embodiments, the I/O components 650 may include output components 652 and input components 654. The output components 652 may include visual components (e.g., a display such as a plasma display panel (PDP), a light emitting diode (LED) display, organic light-emitting diode (OLED), a liquid crystal display (LCD), a projector, or a cathode ray tube (CRT)), electronic paper (e-paper), acoustic components (e.g., speakers), haptic components (e.g., a vibratory motor, resistance mechanisms), other signal generators, and so forth. The input components 654 may include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or other pointing instrument), tactile input components (e.g., a physical button, a touch screen that provides location and/or force of touches or touch gestures, or other tactile input components), audio input components (e.g., a microphone), and the like.

In further example embodiments, the I/O components 650 may include biometric components 656, motion components 658, environmental components 660, or position components 662 among a wide array of other components. For example, the biometric components 656 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 658 may include acceleration sensor components (e.g., accelerometer), gravitation sensor components, rotation sensor components (e.g., gyroscope), and so forth. The environmental components 660 may include, for example, illumination sensor components (e.g., photometer), temperature sensor components (e.g., one or more thermometer that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 662 may include location sensor components (e.g., a Global Position System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 650 may include communication components 664 operable to couple the machine 600 to a network 680 or devices 670 via coupling 682 and coupling 672 respectively. For example, the communication components 664 may include a network interface component or other suitable device to interface with the network 680. In further examples, communication components 664 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 670 may be another machine or any of a wide variety of peripheral devices (e.g., a peripheral device coupled via a Universal Serial Bus (USB)).

Moreover, the communication components 664 may detect identifiers or include components operable to detect identifiers. For example, the communication components 664 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 664, such as, location via Internet Protocol (IP) geo-location, location via Wi-Fi® signal triangulation, location via detecting a NFC beacon signal that may indicate a particular location, and so forth.

### Transmission Medium

In various example embodiments, one or more portions of the network 680 may be an ad hoc network, an intranet, an extranet, a pager network, a Simple Network Paging Protocol (SNPP), a Telelocator Alphanumeric Protocol (TAP), FLEX, ReFLEX, Post Office Code Standardisation Advisory Group (POCSAG), GOLAY, Enhanced Radio Messaging System (ERMS), and NTT, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, the network 680 or a portion of the network 680 may include a wireless or cellular network and the coupling 682 may be a Code Division Multiple Access (CDMA) connection, a Global System for Mobile communications (GSM) connection, or other type of cellular or wireless coupling. In this example, the coupling 682 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, fifth generation wireless (5G) networks, Universal Mobile Telecommunications System (UMTS), High Speed Packet Access (HSPA), Worldwide Interoperability for Microwave Access (WiMAX), Long Term Evolution (LTE) standard, others defined by various standard setting organizations, other long range protocols, or other data transfer technology.

The instructions 616 may be transmitted or received over the network 680 using a transmission medium via a network interface device (e.g., a network interface component included in the communication components 664) and utilizing any one of a number of well-known transfer protocols (e.g., hypertext transfer protocol (HTTP)). Similarly, the instructions 616 may be transmitted or received using a transmission medium via the coupling 672 (e.g., a peer-to-peer coupling) to devices 670. The term “transmission medium” shall be taken to include any intangible medium that is capable of storing, encoding, or carrying instructions 616 for execution by the machine 600, and includes digital or analog communications signals or other intangible medium to facilitate communication of such software.

### Language

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the inventive subject matter has been described with reference to specific example embodiments, various modifications and changes may be made to these embodiments without departing from the broader scope of embodiments of the present disclosure. Such embodiments of the inventive subject matter may be referred to herein, individually or collectively, by the term “invention” merely for convenience and without intending to voluntarily limit the scope of this application to any single disclosure or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

What is claimed is:

1. A method comprising:
receiving a speech signal that comprises speech data via an input component;
accessing a message repository associated with a user profile, the message repository comprising one or more messaging sessions, each messaging session among the one or more messaging sessions comprising a set of terms and corresponding with a set of user identifiers associated with one or more users engaged in each messaging session;
performing natural language processing upon the speech data of the speech signal;
detecting, based on the natural language processing performed upon the speech data, a term from among a set of terms associated with a messaging session from among the one or more messaging sessions associated with the user profile, the messaging session corresponding with at least a user identifier; and
causing display of a notification at a client device associated with the user identifier based on the term.

2. The method of claim 1, wherein the term includes a patient name.

3. The method of claim 1, wherein the performing the natural language processing upon the speech data of the speech signal further comprises:
receiving a request to perform the natural language processing upon the speech data of the speech signal; and
performing the natural language processing responsive to the request.

4. The method of claim 3, wherein the request includes an input that selects a graphical icon.

5. The method of claim 3, wherein the request includes an activation term from a portion of the speech data.

6. The method of claim 1, wherein the notification includes a presentation of the term.

7. The method of claim 1, wherein the messaging session corresponds with a plurality of user identifiers that include the user identifier, and wherein the causing display of the notification at the client device associated with the user identifier further comprises:
selecting a subset of the plurality of user identifiers based on the term detected within the speech data, the subset of the plurality of user identifiers including the user identifier.

8. The method of claim 1, wherein the messaging session comprises a set of attributes, and wherein the notification includes a display of at least a portion of the set of attributes of the messaging session.

9. A system comprising:
one or more processors; and
a memory storing instructions that, when executed by at least one processor among the one or more processors, cause the system to perform operations comprising:
receiving a speech signal that comprises speech data via an input component;
accessing a message repository associated with a user profile, the message repository comprising one or more messaging sessions, each messaging session among the one or more messaging sessions comprising a set of terms and corresponding with a set of user identifiers associated with one or more users engaged in each messaging session;
performing natural language processing upon the speech data of the speech signal;
detecting, based on the natural language processing performed upon the speech data, a term from among a set of terms associated with a messaging session from among the one or more messaging sessions associated with the user profile, the messaging session corresponding with at least a user identifier; and
causing display of a notification at a client device associated with the user identifier based on the term.

10. The system of claim 9, wherein the term includes a patient name.

11. The system of claim 9, wherein the performing the natural language processing upon the speech data of the speech signal further comprises:
receiving a request to perform the natural language processing upon the speech data of the speech signal; and
performing the natural language processing responsive to the request.

12. The system of claim 10, wherein the request includes an input that selects a graphical icon.

13. The system of claim 10, wherein the request includes an activation term from a portion of the speech data.

14. The system of claim 9, wherein the notification includes a presentation of the term.

15. The system of claim 9, wherein the messaging session corresponds with a plurality of user identifiers that include the user identifier, and wherein the causing display of the notification at the client device associated with the user identifier further comprises:
selecting a subset of the plurality of user identifiers based on the term detected within the speech data, the subset of the plurality of user identifiers including the user identifier.

16. The system of claim 9, wherein the messaging session comprises a set of attributes, and wherein the notification includes a display of at least a portion of the set of attributes of the messaging session.

17. A non-transitory machine-readable storage device storing instructions that, when executed by one or more processors, cause the one or more processors to perform operations comprising:
receiving a speech signal that comprises speech data via an input component;
accessing a message repository associated with a user profile, the message repository comprising one or more messaging sessions, each messaging session among the one or more messaging sessions comprising a set of terms and corresponding with a set of user identifiers associated with one or more users engaged in each messaging session;
performing natural language processing upon the speech data of the speech signal;
detecting, based on the natural language processing performed upon the speech data, a term from among a set of terms associated with a messaging session from among the one or more messaging sessions associated with the user profile, the messaging session corresponding with at least a user identifier; and
causing display of a notification at a client device associated with the user identifier based on the term.

18. The non-transitory machine-readable storage device of claim 17, wherein the term includes a patient name.

19. The non-transitory machine-readable storage device of claim 17, wherein the performing the natural language processing upon the speech data of the speech signal further comprises:
receiving a request to perform the natural language processing upon the speech data of the speech signal; and
performing the natural language processing responsive to the request.

20. The non-transitory machine-readable storage device of claim 19, wherein the request includes an input that selects a graphical icon.
